(19) United States
(12) Patent Application Publication
(10) Pub. No.: US 2009/0141023 A1
(43) Pub. Date: Jun. 4, 2009

(54) SELECTIVE FILTERING OF USER INPUT DATA IN A MULTI-USER VIRTUAL ENVIRONMENT

(76) Inventor: Brian Mark Shuster, Vancouver (CA)

Correspondence Address: CONNOLLY BOVE LODGE & HUTZ LLP, P.O. BOX 2207, WILMINGTON, DE, 19899, US

(21) Appl. No.: 12/325,956

(22) Filed: Dec. 1, 2008

Related U.S. Application Data
(60) Provisional application No. 60/990,982, filed on Nov. 29, 2007.

(51) Int. Cl. G06T 15/00

(52) U.S. Cl. 345/419

(57) ABSTRACT

A multi-user animation process provides a modeled three-dimensional (“3D”) environment and virtual reality (“VR”) data to remote clients. The VR data comprises data for animating avatars in the modeled 3D environment. The remote clients provide input data including an ignore signal in response to commands from corresponding users. The multi-user animation process receives the input data, aggregates the input data from each of the remote clients, filters the aggregated input data in response to the ignore signal by removing the input data of a selected one of the remote clients from the aggregated input data, generates updated VR data for each of the remote clients using the filtered aggregated input data and provides an updated modeled 3D environment and the updated VR data to the remote clients. The remote clients display the updated modeled 3D environment and the updated VR data to the corresponding users.

### CROSS-REFERENCE TO RELATED APPLICATIONS

This application claims priority pursuant to 35 U.S.C. § 119(e) to U.S. provisional application Ser. No. 60/990,982, filed Nov. 29, 2007, which is hereby incorporated by reference in its entirety.

### BACKGROUND

1. Field of the Inventions

The present invention relates to a multi-user virtual computer-generated environment in which users are represented by computer-generated avatars, and in particular, to a multi-user animation process that selectively filters user input data from the multi-user virtual computer-generated environment.

2. Description of Related Art

Computer-generated virtual environments have become increasingly popular mediums for people, both real and automated, to interact within a networked system. There exist numerous examples of such virtual environments, three-dimensional (3D) or otherwise. In known virtual environments, users may interact with each other through avatars, comprising at least one man, woman or other being. Users send input data to a virtual reality universe (VRU) engine to move or manipulate their avatars or to interact with objects in the virtual environment. For example, a user's avatar may interact with an automated entity or person, simulated static objects, or avatars operated by other players.

VRU's are known in the art that model a three-dimensional (3D) space. The VRU may be used as an environment through which different connected clients can interact. Such interaction may be controlled, at least in part, by the location of avatars in the 3D modeled space. Clients operating avatars that are within a defined proximity of each other in the modeled space, or inside a defined space such as, for example, a virtual nightclub, may be able to interact with each other. For example, clients of avatars within a virtual nightclub may be connected using electronic chat. Also, each client may observe, and possibly interact, with other clients operating avatars within the client's field of view, or within reach of the client's avatar, through an animation engine of the VRU that animates the avatars in response to input from respective clients. The VRU may therefore replicate real-world interactions between persons, though operation of the avatars to interact with other users, for example to engage in conversation, stroll together, dance or do any other of a variety of activities. As in a real nightclub, however, sometimes attention from other persons is unwanted. Use of the VRU environment to communicate unwanted information may degrade the VRU experience for participating users, and waste valuable bandwidth.

### SUMMARY

The present disclosure describes features to facilitate selectively filtering user input data pertaining to avatars operated by users from remotely located clients in a multi-user VRU environment, to enhance user enjoyment of the VRU and/or conserve valuable bandwidth. The selective filtering enables users to ignore one or more specific avatars in a multi-user VRU environment, while maintaining any ignored avatar in an active (i.e., not ignored) state for other users of the VRU environment.

In one embodiment, a system for filtering selected input data from a multi-user virtual environment is described. The system comprises a network interface disposed to receive input data from a plurality of remote clients, including a requesting client. The input data from the requesting client may comprise an ignore signal indicating one or more selected remote clients to be ignored. The system also comprises a memory holding program instructions operable for generating virtual reality (“VR”) data for each of the remote clients based on the received input data from the plurality of remote clients. A processor, in communication with the memory and the network interface, is configured for operating the program instructions.

In accordance with one aspect of the embodiment, the system further comprises a database server for storing data relating to a modeled three-dimensional (“3D”) environment and the VR data to a database. The data relating to the modeled 3D environment and the VR data may be allocated between the database and the remote clients. The memory may further hold program instructions operable for providing the modeled 3D environment and the VR data to each of the remote clients.

Under the control of the application program instructions, the processor may generate first VR data for a specific requesting client based on aggregated input data received from the remote clients that the processor filters to remove the input data from selected remote clients to be ignored. The processor may do this in response to receiving a request from the specific client that identified or selected one or more avatars present in the VRU to be ignored. Meanwhile, the processor may generate second VR data that is identical to the first VR data except that the second VR data is not filtered to remove the input data from the selected remote clients. The processor may provide the second (unfiltered) VR data to other clients participating in the VR environment.

Thus, the processor may generate the VR data for the one or more selected remote clients based on aggregated input data that the processor filters to remove the VR input data from a selected client that the receiving client has chosen to ignore. In the alternative, or in addition, the processor may configure the VR data for the requesting client to enable the requesting client to identify and filter the VR data, to remove the VR input data associated with the selected remote clients to be ignored. The VR input data may include data received from the client operating the avatar to be ignored, processor-generated data provided in response to data received from the client operating the avatar to be ignored, or both.

The processor may receive the ignore signal identifying the one or more selected remote clients to be ignored based on selection criteria designated by the requesting client. The selection criteria may be any one or more of: age, gender, sexual preference, rating, number of points or credits, geographic location, preferred language, political affiliation, religious affiliation, number and/or recency of interactions between the avatar being being ignored and the client's avatar, number and/or recency of interactions between the avatar being ignored and other avatars with which the client's avatar is affiliated and/or has interacted, and membership in an organized club or group of a user associated with the remote client, an avatar associated with the user, or both. The processor may apply selection criteria identified by the client to determine which, if any, avatars currently operating in the VRU the client desires to ignore. The processor may then filter the VR data pertaining to the ignored avatar or avatars as outlined above for the requesting client only, while providing unfiltered VR data to other clients participating in the VRU.

Furthermore, the selection criteria may be applied when factors other than a desire by an avatar's client to ignore is the reason. One use of such criteria is avoid exceeding the processing or bandwidth limitations of the system by limiting the number of other avatars or other environmental elements with which an avatar may interact. In such a case, for example, where the hardware on which the avatar's client is running the software cannot simultaneously handle interactions between more than ten avatars, the ignore function might be automatically triggered when an eleventh avatar enters the virtual space. In such a case, the software would identify the avatar to be ignored using one or more of the plurality of selection criteria previously described. In a preferred implementation, no avatar with which the client has recently interacted would be selected for the ignore function unless expressly selected by the client.

In accordance with the foregoing, the memory may hold program instructions operable for any one or more of aggregating the input data received from the plurality of remote clients, filtering the aggregated input data in response to the ignore signal by removing the input data of the selected remote clients to be ignored from the aggregated input data for the requesting client, and providing the modeled 3D environment and the VR data to each of the remote clients customized to each clients requesting filter setting.

In accordance with the foregoing, a computer-implemented method for ignoring users in a multi-user virtual environment comprises receiving input data from remote clients connected to a VRU host. Each of the remote clients sends the input data to the host in response to a set of commands from related users operating the respective clients. For example, the client may send different input data if user input indicates “avatar move left,” or “avatar move right.” The input data comprises an ignore signal indicating one of the remote clients to be ignored. For example, a first client may send a signal indicating that input from a second client should be ignored so far as the first client is concerned. The ignore signal may identify the first and second clients, and what input from the second client should be ignored, up to and including all input from the second client. The VRU host may then aggregate the input data received from each of the remote clients, prior to preparing aggregated output data for each respective client. The host or clients may filter the aggregated output data in response to the ignore signal by removing the input data of the selected one of the remote clients from the aggregated output data for each of the remote clients that has signaled that the selected client is to be ignored. The VRU host may generate VR data for each of the remote clients using the filtered aggregated output data. The host and its connected clients may work in coordination to provide a modeled 3D environment output at each of the remote clients, typically in the form of an animated visual display, optionally with associated audio output.

The foregoing process may be configured to permit any connected client to ignore or block input arising from any other connected client in the virtual nightclub. For example, a first client operating an avatar labeled “Jane” may wish to ignore all input from a certain second client operating an avatar labeled “John.” The first client may generate an ignore signal in any of various ways, for example, by right-clicking on an image of the avatar “John” displayed on a display device of the first client, and selecting “ignore” from a menu. The first client then generates an ignore signal that indicates the identities of the first and second client, and what is to be ignored (in this example, “all input”). Thereafter, the VR host may filter all data originating from the second client, removing such data before sending VR output data to the first client. Likewise, the VR host may filter all data originating from the first client, removing such data before sending VR output data to the second client. In the alternative, or in addition, either or both of the first and second clients may filter and remove the ignore data. Either way, the effect of this process may be that the avatar John, and any data from the associated second client such as chat data, disappears from the display screen of the first client. Likewise, the avatar Jane and any associated data disappears from the display screen of the second client. Meanwhile, for further example, a third client operating an avatar “Moonbeam” that has not selected any client for ignoring may receive and process non-filtered data, therefore displaying both avatars Jane and John with corresponding input from the first and second clients. Conversely, the first and second clients may both be able to receive input data from the third client and display the avatar Moonbeam on their respective display devices.

To avoid confusion for the people operating the other avatars within the same environment, in a preferred implementation the ignore function is graphically or textually displayed to the clients of such avatars. The ignore function may be displayed by imposing a physical barrier between the parties to the ignore, such as an automated avatar, optionally marked as computer-operated, who would be constantly repositioned to stand between the avatars that are parties to the ignore. The barrier may also be fanciful, such as a depiction of a floating shield or similar barrier. The barrier may also be communicated by having the avatar being spoken to automatically take up a physical position indicative of an ignore, such as holding a hand up in the “stop” (or “say it to the hand”) posture. The barrier may also be simply and unobtrusively depicted, such as by rendering a small red line between the parties to the ignore.

In addition, or in the alternative, a computer-implemented method for ignoring users in a multi-user virtual environment may comprise receiving a modeled 3D environment and VR data from a server. The VR data may comprise data aggregated from input data received from multiple remote clients and may be received by any one or ones of the multiple remote clients. The modeled 3D environment and the VR data may be displayed to a first user operating the client that receives the VR data. The client may provide input data to the server in response to a first set of commands from the first user, wherein the input data comprises an ignore signal selecting another one of the remote clients to be ignored. The client operated by the first user may then receive updated VR data from the server. The updated VR data may be generated by the server, at least in part by aggregating the input data received from the remote clients to generate data for providing an updated three-dimensional (3D) modeled environment on the respective clients. The input data of a second remote client selected by the first client for ignoring, meanwhile, may have been provided to the server in response to a second set of commands from a second user. The first client may identify the input data of the second remote client within the updated VR data, and filter the updated VR data by removing the input data of the selected remote client from the updated VR data. The second client may display the updated modeled 3D environment and the filtered updated VR data to the first user. Results that are the same as or similar to the example given above may thereby be achieved.

The system may provide various options for selection of clients to be ignored, and what form of data to be ignored. These options may be selected by the remote users through operation of their respective client stations. Besides selecting individual avatars for ignoring, a user may select multiple avatars for ignoring by designating applicable selection criteria. The system may be configured such that any avatar matching the selection criteria will be ignored. Selection criteria may include, for example, user preferences or characteristics associated with respective avatars, including but not limited to: user age, gender, sexual preference, how the user has been rated by other users, value of points or credits accumulated by the user, user's geographic location, user's preferred language, political affiliation, religious affiliation, or membership in an organized club or group. Thus, a user may choose to ignore inputs from any number of other users based on personal preferences.

The ignoring function may be one-way, or two-way. In one-way ignoring, the ignored client may still see and receive data from the client that has put the ignore function in place. In two-way ignoring, both clients are blocked from receiving input data from the other, regardless of which client has initiated the ignore function.

A more complete understanding of the method and system for operating an ignore function in a multi-user virtual reality environment will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is an exemplary screenshot of a number of avatars in a virtual nightclub.

FIG. 2 is a schematic block diagram of an exemplary multi-user virtual environment.

FIG. 3 is a schematic block diagram of an exemplary remote client.

FIG. 4 is an exemplary multi-user animation process for operating an ignore function in a multi-user virtual environment.

FIG. 5 is an exemplary multi-user animation process for operating an ignore function in a multi-user virtual environment.

### DETAILED DESCRIPTION OF VARIOUS EMBODIMENTS

The present method and system provides for operation of an ignore function in a multi-user virtual environment. In the detailed description that follows, like element numerals are used to describe like elements appearing in one or more of the figures.

One of ordinary skill in the art will find that there are a variety of ways to design a client or server architecture. Therefore, the methods and systems disclosed herein are not limited to a specific client or server architecture. For example, operating an ignore function may be performed at a client level or a server level. There may be advantages, for example, to performing calculations and processor commands at the client level if possible, thereby freeing up server capacity and network bandwidth.

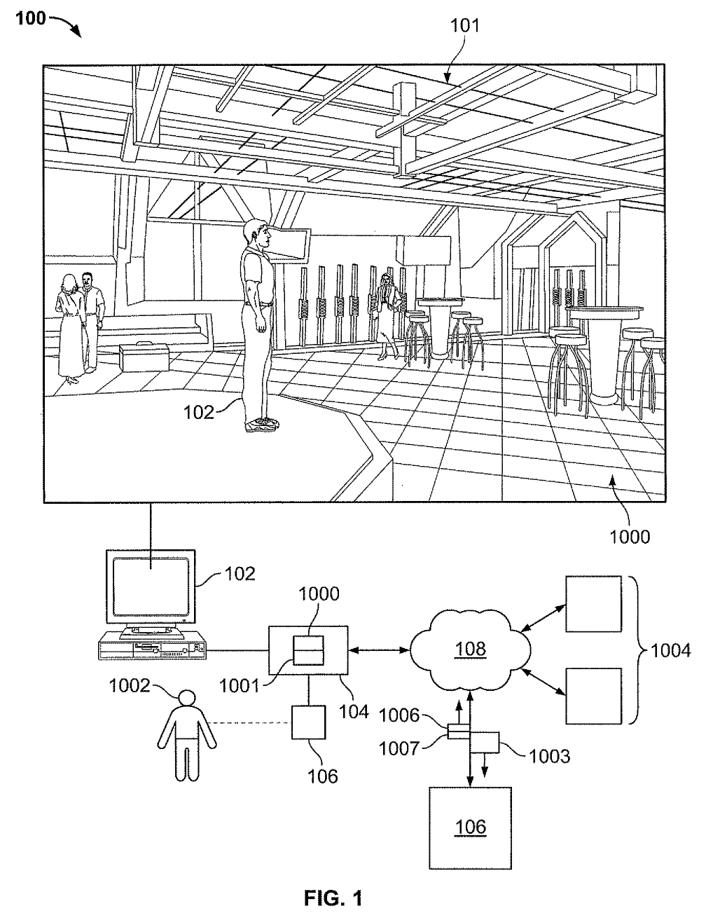

FIG. 1 shows an exemplary screenshot 100 of a plurality of avatars in a virtual nightclub, such as may appear on a display device 102 of a remote client 104 connected to a VR host 106 via a wide area network 108. The remote client, for example, may display a rendered version of a modeled 3D environment 1000 and virtual-reality (“VR”) data 1001 to a user 1002. The modeled 3D environment 1000 may comprise, for example, the ground, walls, objects and fixtures within the virtual nightclub 101. The VR data 1001 may comprise, for example, position, location, chat, emotive, animated facial, animated body language or any other type of data that may be implemented in an avatar or other modeled objects that move within in the modeled 3D environment 1000. Location may be expressed as coordinates with the VRU space. Position may be expressed as a predefined static or variable pose of an articulated figure, for example, a set of joint angles for an articulated figure. Emotive and body language data refers to data that specifies particular modeled facial expressions (static or animated) and poses (static or animated). For example, the emotion “happy” may relate to a predefined animated smile for an avatar. The VR data 1001 may comprise input data 1003 from multiple remote clients 1004 and client 1000, or more preferably, input data that is processed and filtered by host 106. The VR data 1001 may be data processed using the input data 1003 and may also include other data. The VR data 1001 may be unique to each of the remote clients 1004, 1000. In the alternative, each client may receive the same VR data and perform filtering or other processing at the client level to obtain a client-specified view of the modeled 3D environment and objects moving therein.

The virtual nightclub 101 is merely an example of one part of a modeled 3D environment 1000 that may be developed by one of ordinary skill. Likewise, the VR data 1001 are system parameters that depend on the particular system design. The user 1002 may manipulate an avatar 102 in the virtual nightclub 101 by inputting commands to the remote client 104 via an input device 106, such as a keyboard, microphone, mouse, trackball, joystick, or motion sensor. In the alternative, or in addition, the user 1002 may manipulate two or more avatars in the virtual nightclub 101.

The remote client 100 may respond to the commands received via a user interface device by sending a portion of the input data 1003 to a server 106. The server 106 may generate an updated modeled 3D environment 1006 and updated VR data 1007 and transmit to the remote client 100 continuously via network 108. In the alternative, the server 1005 may provide the updated modeled 3D environment 1006 and the updated VR data 1007 to the remote client 100 periodically.

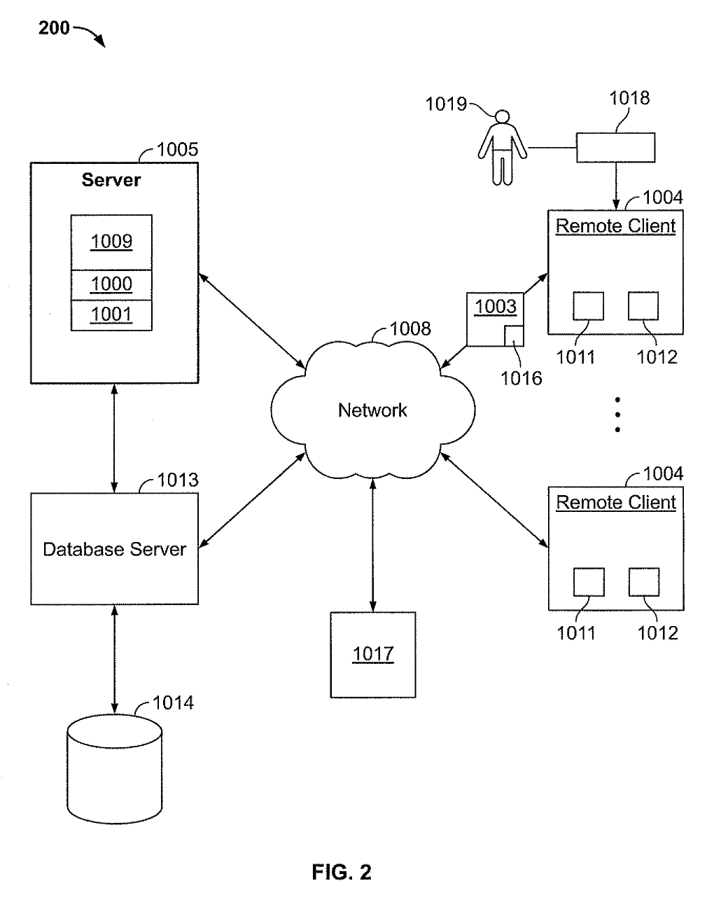

FIG. 2 is a schematic block diagram of an exemplary system and its environment. One skilled in the art would understand that FIG. 2 presents an exemplary combination and ordering of the blocks depicted therein. Various other combinations and orderings of the blocks presented in FIG. 2 will be readily apparent to those skilled in the art without departing from the spirit or scope of the method and system disclosed herein.

Multi-user virtual environment system 200 may comprise a server 1005 connected to remote clients 1004 through a network 1008, such as the Internet. The server 1005 may include a server application such as a Virtual Reality Universe (VRU) Engine 1009. The remote clients 1004 include a display 1011 and a client application 1012. The server application 1009 and the client application 1012 may perform a variety of functions and may be designed to work together through the network 1008. One of ordinary skill in the art would recognize that allocation of functions between the server application 1009 and the client application 1012 may vary depending on the particular system design constraints. The display 1011 may display rendered views of the modeled 3D environment 1000 and the VR data 1001. Avatars and other objects appearing in the environment 1000 may be modeled and updated by the VR data 1001.

The server 1005, for example, may be connected to a database server 1013 for storing backup data relating to the modeled 3D environment 1000 and the VR data 1001 to a database 1014. In the alternative, the database server 1013 may be connected to the server 1005 via the network 1008. The database server 1013 may store the modeled 3D environment 1000 and elements of the VR data 1001. The database server 1013 may further store data for background applications or other necessary applications to be used for the server 1005 or the database server 1013 itself. In the alternative, the remote clients 1004 may store all or part of the modeled 3D environment 1000 and copies of the VR data 1001 or related backup data. Again, allocation of data stored on the database 1014 and the remote clients 1004 may vary depending on the particular system design.

The server 1005 may provide the modeled 3D environment 1000 and the VR data 1001 to each of the remote clients 1004. The modeled 3D environment 1000, for example, may be generic and provided to each of the remote clients 1004. Alternatively, the remote clients 1004 may store the modeled 3D environment 1000 and the server 1005 may provide only the changes in the modeled 3D environment 1000 to the remote clients 1004. In the alternative, or in addition, the modeled 3D environment 1000 may be specific (customized) for particular clients, and different versions of the modeled 3D environment 1000 may be sent to each of the remote clients 1004. The VR data 1001, for example, may be unique to each of the remote clients 1004. Accordingly, a specific version of the VR data 1001 may be provided to each of the remote clients 1004. Alternatively, the VR data 1001 may be generic, being identical for multiple different clients. Likewise, the VR data 1001 may be generic for some of the remote clients 1004 but not to others. The VR data 1001 comprises, for example, position, location, chat, emotive, animated facial, animated body language or any other type of data that for animating events in a virtual environment, such as avatar actions and movement.

The input data 1003 may comprise an ignore signal 1016 selecting one of the remote clients 1004 (e.g., a selected remote client 1017) to be ignored. A remote client sends the ignore signal 1016 in response to an ignore command 1018 from a related user 1019. The input data 1003 may comprise position, location, movement, chat, emotive, animated facial and animated body language signals in addition to the ignore signal 1016. In response to the ignore signal 1016, the server application 1009 may filter the VR data 1001 before providing the VR data 1001 to the remote clients 1004. For example, the server may remove the input data from the selected remote client 1017 before generating the VR data 1001 for the remote client 1004. For clients that have not requested that client 1017 be ignored, the server may generate a different version of VR data 1001 using inputs including the input from client 1017. In the alternative, the server application 1009 may provide unfiltered VR data 1001 to the client application 1012, configured such that the client application 1012 may filter the VR data 1001. Filtering at the server level may increase processing load on the server, while reducing bandwidth requirements for transmitting VR data 1001 to the local clients. Therefore, the optimal location for performing filtering may depend on relative availability of bandwidth or processing resources. Optimization may also be influenced by other parameters of system architecture.

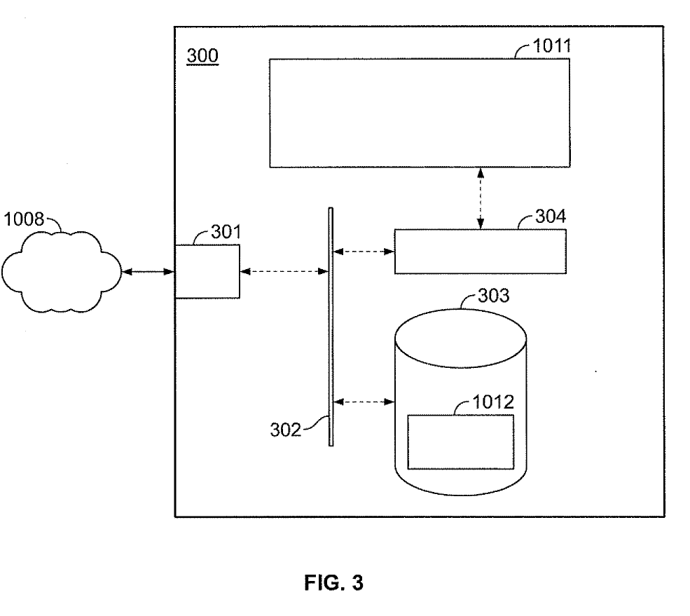

FIG. 3 is a schematic block diagram of an exemplary remote client 300 presenting an exemplary combination and ordering of the blocks. Various other combinations and orderings of the blocks presented in FIG. 3 may be readily apparent to those skilled in the art, without departing from the spirit or scope of the method and system disclosed herein.

In an aspect, a remote client 300 may include a network interface card (“NIC”) 301 connected to the network 1008 and to an internal bus 302. The NIC 301 may allow information to be passed between the remote client 300 and the network 1008. A hard disk 303 may be connected to the internal bus 302. The hard disk 303 may store the client application 1012 and, through the internal bus 302, allows data to be transferred to the NIC 301 or a processor module 304, which may include one or more processors and memory devices. A display 1011 may be connected to the processor module 304. In the alternative, the display 1011 may be connected to the internal bus 302 or other internal connection such as through a video card. As in the discussion under FIG. 2, above, the client application 1012 may perform the filtering function instead of the server application 1009. The client application 1012 may also perform other functionality instead of the server application 1009.

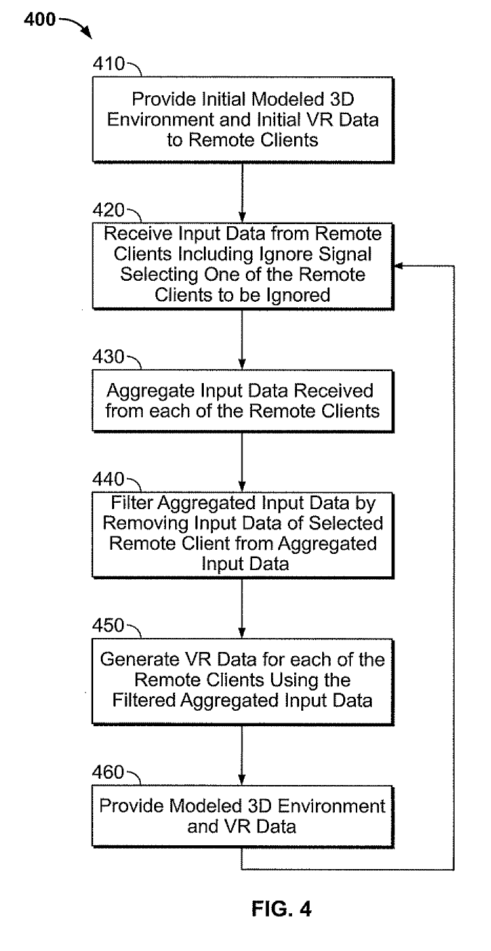

FIG. 4 shows exemplary steps of a multi-user animation process 400 for operating an ignore function in a multi-user virtual environment. Various other combinations and orderings of the steps presented in FIG. 4 may be apparent to those skilled in the art, without departing from the spirit or scope of the method disclosed herein.

At step 410, for example, a multi-user animation process 400 may provide an initial modeled 3D environment and initial VR data to a plurality of remote clients. The initial modeled 3D environment may comprise, for example, the ground, walls, objects, boundaries, and other geometric objects defining the virtual environment. The initial VR data may comprise, for example, position, location, chat, emotive, animated facial, animated body language or any data for animating movement of avatars or other objects in the virtual environment, and for communication between ones of the multiple remote clients. The VR data may comprise input data aggregated from the remote clients, and may also include processed information resulting from processing client inputs. The VR data may be data processed using client input data and may include other processed data as well. The VR data may be unique to each of the remote clients, that is, each client may receive customized VR data for modeling a client-specific instance of the VRU environment.

At step 420, for example, a VRU host may receive the input data from the remote clients. The input data may comprise an ignore signal selecting another one of the remote clients to be ignored. Each of the remote clients may provide its own ignore signal in response to respective ignore commands from users operating each client. A user interface application operating at each client may provide each user with the option to select one or more avatars or other users to ignore. The user interface may also permit the user to designate a time period during which the ignore command will be operative, for example, 1 hour, 24 hours, 1 week, 1 month, or permanently. The user interface may also permit the user to designate what data is to be ignored, for example, VRU model data pertaining to the ignored avatar, chat data originating from the ignored user, audible data from the ignored user, or any combination of the foregoing. The user interface may permit the user to designate a single avatar or user to be ignored, such as by selecting a user name from a list or selecting an avatar from a rendered display of the modeled 3D environment. The user interface may, in addition, permit the user to designate groups or classes of avatars or users to ignore, for example, by gender, age, language, sexual orientation, marital status, interests, geographic proximity, and so forth. For example, the user, via the client user interface, may specify that inputs from clients identified as younger than a defined age are to be ignored. The user interface may further permit the user to specify whether ignore commands are to be carried out in a unilateral or bilateral fashion. The ignore signal may communicate information defining such parameters of an ignore command for use by a host process.

The input data may also comprise other information, for example, position, location, movement, chat, emotive, animated facial and animated body language signals, in addition to an ignore signal. For example, the input data may comprise design or clothing characteristics of a remote client's avatar. The design or clothing characteristics may be stored on each of the remote clients or may be provided by the multi-user animation process via the VR data. The remote clients may also send the input data reflecting a change in the modeled 3D environment. The input data may then further comprise data defining avatar actions within the 3D environment, for example, picking up an object, consuming an object, or otherwise interacting with fixtures or objects within the modeled 3D environment.

At step 430, the multi-user animation process may aggregate the input data received from each of the remote clients to prepare aggregated input data. The input data includes model control data operative to control events occurring in the modeled 3D environment. In addition, the input data comprises ignore signals. A host process may process the model control data as it comes in to determine events occurring in the model space. In the alternative, the host may merely aggregate input data, leaving modeling to be performed locally. In either case, the host allocates output data to be distributed to client nodes depending on each avatar's location in the modeled VRU environment and applicable ignore operations, as discussed further in connection with step 450.

At step 440, the multi-user animation process 400 may filter the aggregated input data or output data to remove data pertaining to an ignored avatar or user from the aggregated input data or output data, thereby preparing filtered aggregated data. The filtered aggregated data is customized for each client based on that client's ignore settings. As such, the filtering may be performed at the host or client level, or at some combination of the host or client levels. Either the host or client may filter out one or more of position, location, movement, chat, emotive, animated facial, animated body language or any other type of data that may be commanded by a user or provided in the form of output VR data.

At step 450, VR data may be generated for each of the remote clients using the filtered aggregated data. Output data may be distributed at periodic intervals, with each data release reporting changes in input and/or modeled output since the last data distribution. The host may send each client node all available output data for the VRU environment. In the alternative, the host may prepare customized data for each client node, reporting to each client less than all available output data, and sufficient data to permit each client to model and/or generate a view of the environment that is local to the client's avatar and that excludes ignored data.

At step 460, the multi-user animation process host may provide the modeled 3D environment and the VR data to each of the remote clients. Each of the participating remote clients may receive a unique version of the VR data depending on the input data provided by each of the remote clients, and the location of each client's avatar in the 3D environment. However, the multi-user animation process host may, for example, group similar versions of the VR data and multicast the version to indicated ones of the remote clients. In an aspect, if the multi-user animation process host receives the input data from a first remote client comprising an ignore signal to ignore a second remote client, the first remote client may receive a different version of the VR data than that which the second remote client receives. In this example, the multi-user animation process host may generate and provide the VR data to the first remote client with the VR data of the second remote client filtered out. In addition, the multi-user animation process host may generate and provide the VR data to the second remote client with the VR data of the first remote client filtered out.

After receiving the VR data, the remote clients may display the modeled environment at respective local display devices. For example, the first remote client may display the 3D environment and avatars modeled therein. However, because of the ignore signal, the display at the first remote client should not show the avatar controlled by the second remote client, even at the location in the 3D modeled environment where that avatar should appear and indeed, actually may appear at the second client or other remote clients. Instead, the first remote client may display the background of the 3D environment. Conversely, in a bilateral ignore, the second client will not display the avatar operated by the first client. Thus, the first and second clients can co-exist in the same 3D modeled space without displaying or receiving input from each other.

As shown by the arrow connecting block 460 with block 420 in FIG. 4, the multi-user animation process 400 may repeat blocks 430, 440, 450 and 460 if it receives additional input data from the remote clients. This process may be continuous or periodic and may be done in parallel with the remote clients.

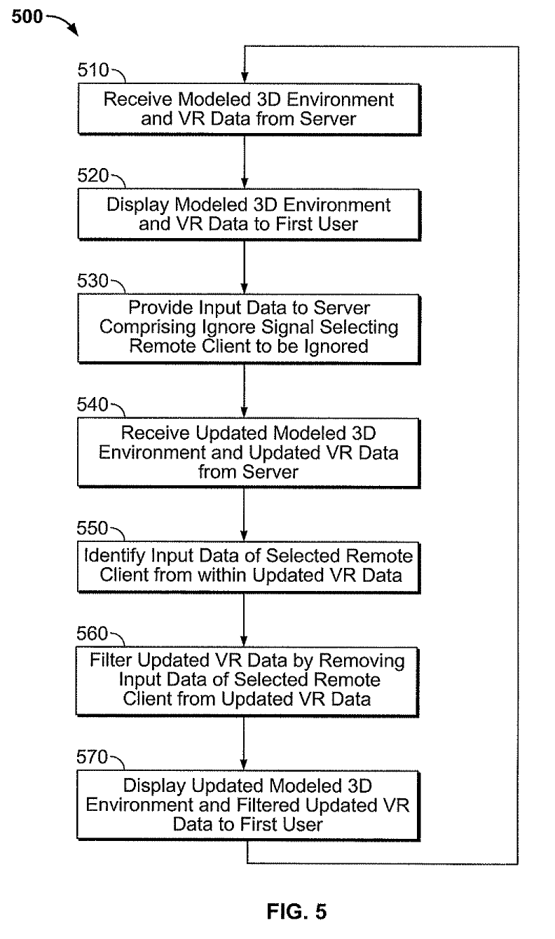

FIG. 5 illustrates an exemplary process 500 for operating an ignore function in a multi-user virtual environment, from a client perspective. One skilled in the art would understand that FIG. 5 presents an exemplary combination and ordering of the illustrated steps. Various other combinations and orderings of the steps presented in FIG. 5 may be apparent to those skilled in the art without departing from the spirit or scope of the method and system disclosed herein.

At step 510, a first remote client may receive the modeled 3D environment data and the VR data from the server. These data may be as previously discussed. At step 520, the first remote client may display the modeled 3D environment including the VR data to a first user. Avatars corresponding with each of various other remote clients and the first remote client may be displayed using the VR data in the modeled 3D environment.

At step 530, the first remote client may provide input data to the host processor, such as, for example, using TCP/IP or other network communication protocol. The input data may be provided to the server in response to a first set of commands from the first user. The input data may comprise an ignore signal specifying one or more of the other remote clients to ignore, as previously discussed. For example, the ignore signal may specify that a second remote client is to be ignored. In such case, the input data of the second remote client may be sent to the host processor in response to a second set of commands from a second user. Generally, one or more of the remote clients may send a corresponding ignore signal in response to an ignore command originating from corresponding ones of the related users. In addition to the ignore signals, the first client and other remote clients may transmit other input data to the host processor, as previously discussed.

At step 540, the first remote client may receive an updated modeled 3D environment and the updated VR data from the host processor. Production and distribution of the updated data is discussed in connection with FIG. 4, and elsewhere in this application. In the process shown in FIG. 5, the updated data may be unfiltered, that is, it may not have been filtered to remove data pertaining to ignored avatars or users before being provided to the first remote client.

At step 550, therefore, the first remote client may identify input data originating from the ignored remote client or clients (for example, from the second remote client) from within the updated VR data. For example, chat data or model data may be associated with an identifier for one or more ignored data. At step 560 the first remote client may filter the updated VR data. When processing the input data to prepare an audio-visual output using its display device, the first remote client may simply ignore the data associated with an identifier for an ignored source. In the alternative, the first remote client may first delete or remove such data from the VR input data, and then process the data to prepare output. In the alternative, or in addition, if the VR input data has already been processed from input data, the first remote client may identify data associated with the one or more client to be ignored from within the updated VR data. For example, the first remote client may identify and remove (or simply not use) VR data used for generating an animated view of one or more corresponding avatars for the ignored clients.

At step 570, the remote client displays the updated modeled 3D environment and the filtered updated VR data to a user operating the first client. The filtered updated VR data enables the client application to display the avatars of the remote clients in the updated modeled 3D environment and track the avatars' position, location, movement, chat, emotive, animated facial expressions, animated body language or other characteristics within that environment. At the same time, display of any avatars operated by clients that the first client has identified for being ignored will not be displayed at the first client, even if such ignored avatars may appear at other clients in the same modeled scene. Likewise, other data originating from ignored clients, such as chat data, may be blocked from being output by the first client for presentation to a user.

As shown by the arrow connecting block 570 with block 510 in FIG. 5, the multi-user animation process 500 may repeat blocks 520, 530, 540, 550 and 560 if it receives additional input from the remote clients. This process may be continuous or periodic and may be done in parallel with the remote clients.

Having thus described embodiments of a method and system for operation of an ignore function in a multi-user animation environment, it should be apparent to those skilled in the art that certain advantages of the within system and method have been achieved. It should also be appreciated that various modifications, adaptations, and alternative embodiments thereof may be made within the scope and spirit of the present invention. The invention is defined by the following claims.

What is claimed is:

1. A system for filtering selected input data from a multi-user virtual environment comprising:
a network interface disposed to receive input data from a plurality of remote clients, including a requesting client, the input data from the requesting client comprising an ignore signal from the requesting client indicating one or more avatars operated using input from selected remote clients to be ignored;
a memory holding program instructions operable for generating virtual reality (“VR”) data for each of the remote clients based on the received input data from the plurality of remote clients, wherein the VR data is selectively filtered in response to the ignore signal; and
a processor, in communication with the memory and the network interface, configured for operating the program instructions.

2. The system of claim 1, further comprising a database server in communication with the processor, the database server storing data relating to a modeled three-dimensional (“3D”) environment and the VR data to a database.

3. The system of claim 2, wherein the data relating to the modeled 3D environment and the VR data is allocated between storage by the database server and by the remote clients.

4. The system of claim 2, the memory further holding program instructions operable for providing the modeled 3D environment and the VR data to each of the remote clients.

5. The system of claim 1, wherein the VR data for the requesting client is generated based on aggregated input data received from the remote clients that has been filtered to remove the input data associated with selected remote clients to be ignored.

6. The system of claim 1, wherein the VR data for the one or more selected remote clients is generated based on aggregated input data that has been filtered to remove data identified by the ignore signal received from the requesting client.

7. The system of claim 1, wherein the VR data for the requesting client is configured to enable the requesting client to identify and filter the VR data to remove a portion of the VR data for displaying at least one avatar identified by the ignore signal.

8. The system of claim 1, wherein the ignore signal identifies the one or more selected avatars to be ignored based on selection criteria designated by the requesting client.

9. The system of claim 8, wherein the selection criteria comprises any one or more of: age, gender, sexual preference, rating, number of points or credits, geographic location, or preferred language.

10. The system of claim 1, the memory further holding program instructions operable for aggregating the input data received from the plurality of remote clients.

11. The system of claim 10, the memory further holding program instructions operable for filtering the aggregated input data in response to the ignore signal by removing the input data of the selected remote clients to be ignored from the aggregated input data provided to the requesting client.

12. The system of claim 11, the memory further holding program instructions operable for providing the modeled 3D environment and the VR data to each of the remote clients.

13. Computer-readable media encoded with instructions operative to cause a computer to perform the steps of:
receiving user input data via a user input device, the user input data comprising an ignore command selecting one or more avatars controlled by participants in a multiple user virtual reality process to be ignored;
providing user input data to a host operative to coordinate data from multiple remote clients in the multi-user virtual reality process;
receiving modeling data from the host, the modeling data developed from data from the multiple remote clients, including the user input data, the modeling data configured for generating an animated depiction of the 3D environment including the one or more avatars to be ignored;
displaying at least a portion of the modeling data on a display device, wherein the modeling data is filtered to remove data associated with the one or more avatars to be ignored.

14. The computer-readable media of claim 13, further operative to provide an interface for selecting the one or more avatars to be ignored.

15. The computer-readable media of claim 14, the interface further operative to receive the input data by a user selection action performed in relation to displaying the one or more avatars.

16. The computer-readable media of claim 14, the interface further operative to provide a list configured to facilitate selection of the one or more avatars.

17. The computer-readable media of claim 13, further operative to provide an interface for identifying the one or more avatars to be ignored as member of a common class of participants.

18. Computer-readable media encoded with instructions operative to cause a computer to perform the steps of:
receiving input data at a host from multiple remote clients for coordinating a multi-user virtual reality process, the input data comprising an ignore signal identifying at least one first participant to be ignored by at least one second participant;
developing modeling data from the input data configured for generating an animated depiction of a 3D environment included in the multi-user virtual reality process including a first avatar controlled by the first participant and a second avatar controlled by the second participant; and
outputting the modeling data to the multiple remote clients, the modeling data configured to cause display at least a portion of the modeling data including the second avatar on a display device operated by the second participant, while omitting any display of the first avatar where the input data indicates that it should appear.

19. The computer-readable media of claim 18, further operative to develop the modeling data configured to cause display of at least a portion of the modeling data including the first avatar and the second avatar on a display device not operated by the second participant.

20. The computer-readable media of claim 19, further operative to develop the modeling data configured to cause display of at least a portion of the modeling data including the first avatar on a display device operated by the first participant, while omitting any display of the second avatar where the input data indicates that it should appear.

21. The computer-readable media of claim 19, further operative to develop different modeling data for each of the remote clients depending on content of ignore signals received from the remote clients.

22. The computer-readable media of claim 19, further operative to remove data received from the first participant from the input data used to develop modeling data for the second participant.

23. The computer-readable media of claim 19, further operative to remove data for modeling the first avatar from modeling data for the second participant.
